(19) United States
(12) Patent Application Publication
(10) Pub. No.: US 2007/0039977 A1
(43) Pub. Date: Feb. 22, 2007

(54) Disposable apparatus for wine preservation

(76) Inventor: Blake F. Donaldson, Hermosa Beach, CA (US)

Correspondence Address: Theodore S. Maceiko;Jones Day, 50th Floor, 555 S. Flower Street, Los Angeles, CA, 90071, US

(21) Appl. No.: 11/443,613

(22) Filed: May 30, 2006

Related U.S. Application Data
(60) Provisional application No. 60/685,183, filed on Aug. 16, 2005.

(51) Int. Cl. G01F 13/00

(52) U.S. Cl. 222/222

(57) ABSTRACT

A disposable, self-contained apparatus for preserving the wine remaining after a bottle of wine has been opened and partially consumed. The apparatus reflects a simple design without the need for separate gas cartridges. The apparatus deposits and maintains a layer of inert gas on the surface of the remaining wine thereby displacing the air-containing oxygen that would otherwise adversely react with the wine. All the air in the headspace need not be purged.

### CROSS-REFERENCE TO RELATED APPLICATIONS

This application claims the benefit of previously filed provisional application Ser. No. 60/685,183, originally filed May 27, 2005, and accorded an Aug. 16, 2005 filing date.

### STATEMENT REGARDING FEDERALLY SPONSORED RESEARCH OR DEVELOPMENT

Not Applicable

### INCORPORATION-BY-REFERENCE OF MATERIAL SUBMITTED ON COMPACT DISC

Not Applicable

### BACKGROUND OF THE INVENTION

1. Field of the Invention

The present invention is generally directed towards an apparatus for preserving the quality of wine not consumed after a bottle of wine is initially opened. More particularly, the present invention is directed to a disposable bottle top cap of simple design that deposits a layer of inert gas over the remaining wine to preserve its quality.

2. Description of Related Art

It is well known that once a bottle of wine is opened, the wine's exposure to air will quickly deteriorate the wine's quality in as little as one day. See, e.g., U.S. Pat. No. 4,392,578. It is the exposure to oxygen—the second most common element in air—that causes the wine to quickly deteriorate by a chemical reaction known as oxidation. Thus, when air is permitted into the headspace of a wine bottle (i.e., the internal volume of the wine bottle not occupied by the remaining wine), and the wine bottle is then re-corked, the oxygen-containing air trapped inside the headspace will quickly oxidize the wine and degrade the wine's quality.

Numerous efforts have been made to prevent oxidation of the wine not consumed after the initial corking so that this remaining wine is preserved and its shelf-life extended. These efforts, however, have resulted in complex mechanical devices that are not simple to manufacture, use or maintain. Furthermore, at least some of these devices also require replaceable cartridges.

For example, U.S. Pat. No. 4,473,174 discloses an apparatus that ultimately serves as a wine dispenser. When received by the previously opened wine bottle, the apparatus effectively purges the oxygen-containing air from the headspace with an inert gas. The inert gas is further pressurized inside the headspace such that wine is forced through a vent in the apparatus and dispensed to the user. This bulky item prevents a user from being able to pour wine from a bottle, and also includes complex valves, spigots, insertion tubes and venting channels. This apparatus also requires separate cartridges of inert gas that must be replaced in the apparatus after multiple uses. Other patents disclosing similarly complex mechanical devices and involving increased manufacturing cost are U.S. Pat. Nos. 4,702,396, 5,566,730, 6,530,401 B1, 6,595,109 B2.

Another common trait of prior art apparatus is that they strive to purge effectively all oxygen-containing air from the headspace. For example, U.S. Pat. No. 4,475,576 discloses a capping apparatus wherein inert gas is injected into the headspace from a separate container for up to ten seconds. All but a negligible amount of oxygen-containing air is purged from the headspace. A problem associated with purging all or almost all the air from the headspace is the required increase in design complexity and associated cost.

To address this problem, it is believed that the air in the headspace need only be displaced from the wine's surface instead of being completely purged from the headspace. As such, the remaining wine may be preserved because the oxygen molecules are not directly contacting the wine's surface.

In sum, the complexity and awkwardness of prior art apparatus that involve replaceable cartridges and the like, combined with the unnecessary complete purging of air in the headspace has created a strong need for a simple, self-contained, inexpensive and disposable alternative that is capable of preserving the quality of wine not consumed when the bottle is initially opened.

### BRIEF SUMMARY OF THE INVENTION

The present invention solves the problem of providing a convenient and inexpensive apparatus to preserve non-consumed wine in a wine bottle. The present invention, also referred to as the WINE BLANKET™, is of simple design and does not seek to purge all oxygen-containing air from the headspace of a wine bottle. Instead, the apparatus of the present invention uses the natural force of gravity to place an inert, i.e., food-friendly, barrier layer of gas between the remaining wine and the oxidizing air. This barrier effectively prevents oxidation of the remaining wine.

Unlike the costly, complex designs of the prior art which require separate components and pressurized cartridges of inert gas, the present invention is a one-time-use apparatus that is self-contained. The inert gas used by the WINE BLANKET™ is incorporated into the invention and does not require a separate cartridge. Moreover, after the WINE BLANKET™ is dispensed, it then utilizes the natural force of gravity—as opposed to pressurized cartridges—to lay a blanket of inert gas onto the surface of the remaining wine. Furthermore, apparatus of the prior art are mechanically complicated, awkward, and needlessly attempt to purge the entire headspace of a wine bottle. The WINE BLANKET™ provides convenience and simplicity by using the force of gravity to deposit a layer of inert gas on the remaining wine's surface to prevent oxidation.

### BRIEF DESCRIPTION OF THE DRAWING(S)

The following is a brief description of the accompanying drawings that further define the present invention:

FIG. 1 is a sectional drawing of a first preferred embodiment 100 of the present invention.

FIG. 2 is an oblique drawing of piercing shaft 3 used in the first preferred embodiment 100.

FIG. 3 is a sectional drawing of a second preferred embodiment 200 of the present invention.

FIG. 4 is a sectional drawing of the third preferred embodiment 300 of the present invention.

FIG. 5 depicts an embodiment of the present invention including one or more ridges on the shaft.

### DETAILED DESCRIPTION OF THE INVENTION

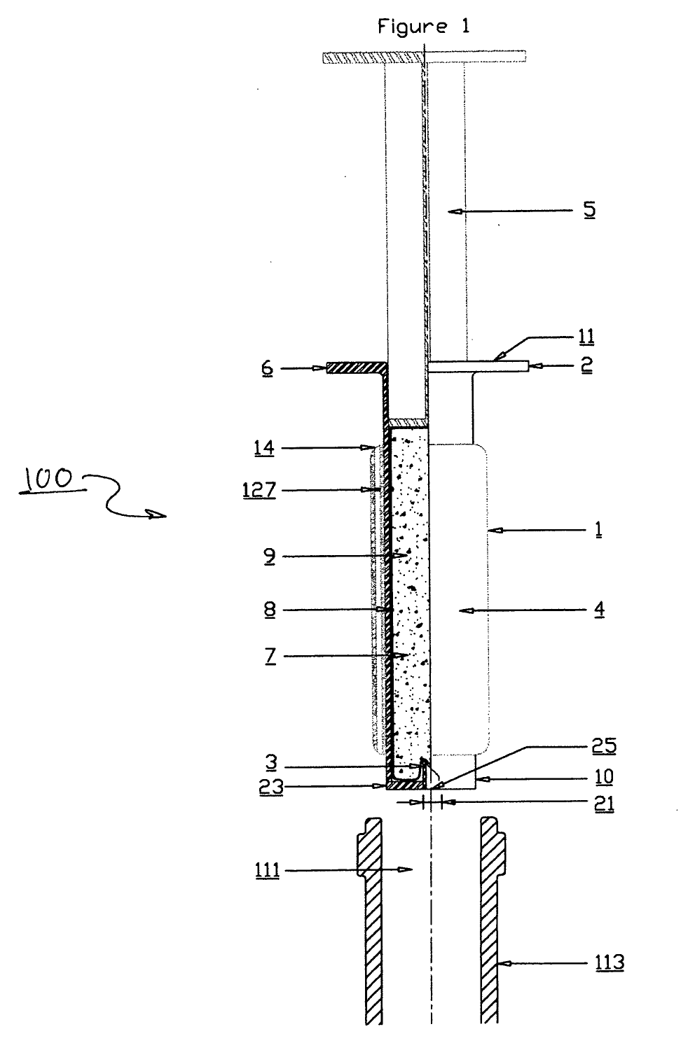

As seen in FIG. 1, a first embodiment 100 of the present invention preferably includes a cylindrical corking shaft 4 and a bottle collar 6. Shaft 4 and bottle collar 6 may comprise one contiguous element or two separate elements attached to each other. In any event, a cavity 9, which may resemble a cylindrical bore, preferably extends through the shaft 4 and bottle collar 6. A bladder 7 containing inert “food friendly” gas is preferably fitted within cavity 9. One end of a plunger 5 fits snugly into shaft 4 at bottle collar 6. In operation, the plunger 5 is moved axially downward in cavity 9 by pressing down on plunger 5, so that bladder 7 is pierced by a hollow piercing shaft 3. As such, inert gas is transferred from bladder 7, through piercing shaft 3, and into the headspace 111 of bottle 113.

The foregoing components are now particularly described. The corking shaft 4 may have a shaft outer-diameter (“OD”) 1 that is generally determined by the inner-diameter (“ID”) of the neck of the wine bottle 113 into which the first embodiment 100 of WINE BLANKET™ is inserted. The dimension of shaft OD 1 may vary according to different bottle sizes. In any event, shaft OD 1 is preferably sized to achieve a snug fit between shaft OD 1 and the ID of the neck of the wine bottle 113. This snug fit ensures that gases within the wine bottle's headspace 111 are unable to escape after the corking shaft 4 has been inserted into the ID of the neck of the wine bottle 113. As discussed later, and as shown by the sectional view of FIG. 1, corking shaft 4 preferably includes a solid section 23 at its bottom, and a cavity 9 located above.

The corking shaft 4 may comprise any type of cork, rubber or other suitable material having a modulus that may slightly compress under the forces created by insertion of the corking shaft 4 into the neck of the wine bottle 113.

A bottle collar 6 may be contiguous to, or attached on one end of, the corking shaft 4. The bottle collar 6 may have a cap OD 2 that is larger than shaft OD 1. The cap OD 2 is preferably larger than the ID of the neck of the wine bottle into which the first preferred embodiment 100 of WINE BLANKET™ is inserted. This avoids the corking shaft 4 from being accidentally inserted past the wine bottle neck and into the headspace 111 of the wine bottle 113, and also allows the user to easily remove the WINE BLANKET™ from the wine bottle 113.

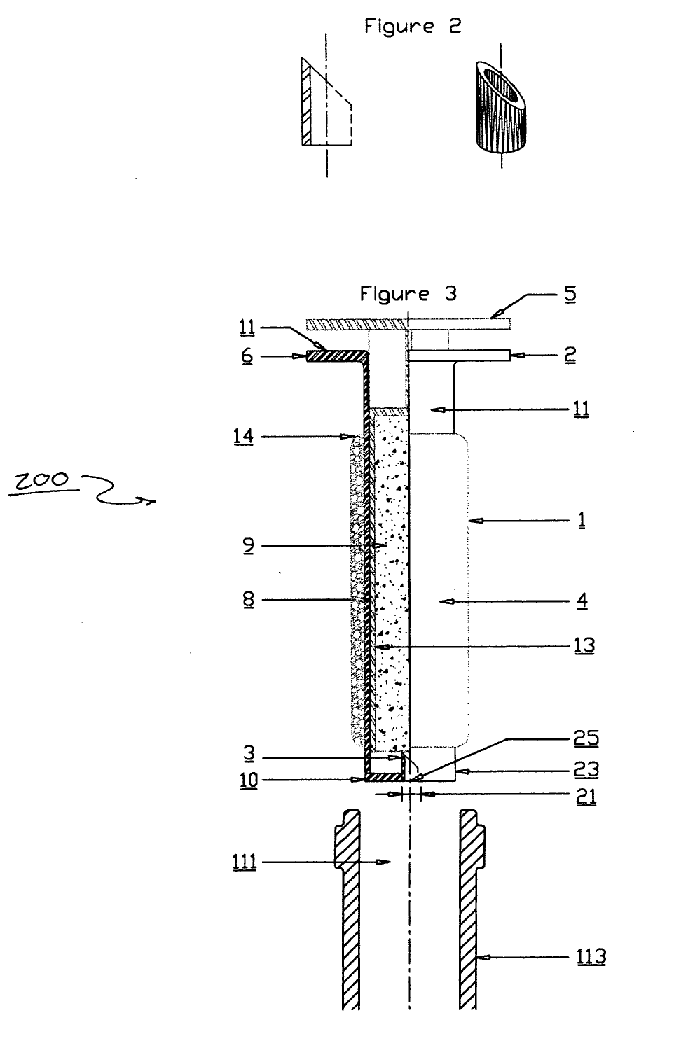

The insertion end 10 of corking shaft 4 preferably includes a piercing shaft 3 as shown in FIG. 2. Piercing shaft 3 is preferably tubular and concludes with a pointed tip for piercing a bladder 7 containing inert gas as described later. The pierce shaft OD 21 of piercing shaft 3 is preferably smaller than the cavity ID 8 discussed later.

The piercing shaft 3 is preferably located within a hole 25 of the solid section 23. Piercing shaft 3 may be attached within hole 25 by a pressure fit, an adhesive or other suitable means. Alternatively, the piercing shaft 3 may be attached on top of the hole 25 or form a contiguous part of corking shaft 4. One end of piercing shaft 3 is generally flush with the insertion end 10 as shown in FIG. 1. The other end of piercing shaft 3 preferably extends up axially through corking shaft 4 and into cavity 9 located within corking shaft 4.

The piercing shaft 3 is preferably made of a material that is resilient enough to pierce bladder 7 when bladder 7 is pressed onto piercing shaft 3. However, it is also preferred that piercing shaft 3 comprise a material that may be manufactured inexpensively and efficiently. It is also preferred that the material of shaft 3 not react with the inert gas. For example, piercing shaft 3 may comprise suitable plastics or the like.

The cavity 9 of first preferred embodiment 100 is defined by a cavity ID 8 that is sufficiently smaller than shaft OD 1 so that corking shaft 4 has sufficient rigidity. The cavity 9 generally runs axially through bottle collar 6 and corking shaft 4 and stops at the solid section 23 at insertion end 10 as shown in FIG. 1. The distance between the bottom end of cavity 9 and the bottom of insertion end 10, i.e., the height of solid section 23, is preferably thick enough to contribute to the rigidity of corking shaft 4.

The bladder 7 contains a safe, food-friendly inert gas. The bladder 7 preferably comprises a material resilient enough to contain a volume of inert gas but which may be collapsed down and also punctured by piercing shaft 3. The inert gas contained within bladder 7 preferably has a density greater than air at the same pressure (i.e., atmospheric pressure).

After a wine bottle has been opened and partially consumed, the first preferred embodiment 100 of WINE BLANKET™ may be used to preserve the quality of the remaining wine as follows. The user generally inserts the corking shaft 4 into the neck of the wine bottle. The shaft OD 1 (of shaft 4) preferably fits snugly with the ID of the neck of the wine bottle so that gases do not escape from the headspace 111 of the wine bottle 113. It is preferred that the corking shaft 4 be fully inserted into the neck of the wine bottle such that the bottom edge of bottle collar 6 abuts the lip of the wine bottle.

After insertion of the first preferred embodiment 100, the user may gently press the plunger 5, causing the bladder 7 to slide towards the piercing shaft 3. The user may then continue to supply sufficient force to the plunger 5 causing the bladder 7 to move far enough in an axial direction through cavity 9 so that it impinges upon piercing shaft 3.

In the process of sliding bladder 7 axially through cavity 9, the bladder 7 comes into contact with, and is pierced by, the piercing shaft 3. In this manner, the inert gas is released from the bladder 7, forced through the hollow piercing shaft 3 and ultimately deposited into headspace 111. The user may continue to press down on plunger 5 thereby fully collapsing bladder 7 and transferring all of the inert gas through piercing shaft 3 and into headspace 111. Beside the force of internal pressure provided by the collapsing bladder 7, the natural force of gravity will cause the inert gas to travel through the piercing shaft 3 and into the headspace 111 of the wine bottle (assuming that the wine bottle 113 is right-side up). Because the inert gas is denser than the air contained within the headspace 111, the inert gas will continue down the headspace 111 (toward the surface of the remaining wine) under the natural force of gravity. Ultimately, when equilibrium is reached, the inert gas generally displaces the oxygen-containing air that had been located at the surface of the remaining wine, and blankets the surface of the remaining wine with a thin layer of inert, food-friendly gas.

As the inert gas is introduced into the headspace of the wine bottle, the headspace will naturally become pressurized. An oxygen vent 14 with a one-way valve 127 will allow for the release of the less dense air that is displaced by the more dense inert gas. More specifically, the oxygen vent 14 preferably extends within shaft 4 and bottle collar 6 from the insertion end 10 to the cap end 11. As such, the oxygen vent 14 is in proximity to the upper portion of the headspace 111 occupied by the less dense air that has been displaced by the more dense inert gas acting under gravity and pressure from the collapsed bladder 7. The first preferred embodiment 100 generally displaces only enough air from the headspace 111 as is necessary to allow the inert gas to be introduced into the headspace 111 without significant pressurization of the headspace 111.

The blanketing layer of inert gas that ultimately settles on the surface of the remaining wine generally acts as a barrier, substantially preventing oxygen molecules in the headspace 111 from coming in direct contact with the wine. Oxidation is thus substantially prevented, and because the inert gas is safe and food-friendly, no significant chemical reactions occur between the inert gas and the remaining wine.

Thereafter, the user may remove the first preferred embodiment 100 of WINE BLANKET™ from the wine bottle and discard it. The remaining wine will have been subject to only minimal oxidization, thus helping preserve the integrity of the wine that existed when the wine bottle was first opened. The inert gas that acted as a protective barrier for the non-consumed wine harmlessly dissipates into the air after the first preferred embodiment 100 of WINE BLANKET™ is removed and the wine poured.

Alternatively, as seen in FIG. 3, a second preferred embodiment 200 of the WINE BLANKET™ preferably includes a cylindrical corking shaft 4 and a bottle collar 6. Shaft 4 and bottle collar 6 may comprise one contiguous element or two separate elements attached to each other. In any event, a cavity 9, which may resembles a cylindrical bore, preferably extends through the shaft 4 and bottle collar 6. One end of a plunger 5 fits snugly into cavity 9 at bottle collar 6. Attached to plunger 5, and located within cavity 9, is a rigid inner chamber 13. The rigid inner chamber 13 contains inert “food friendly” gas. In operation, the rigid inner chamber 13 is moved axially through cavity 9 (towards piercing shaft 3) by pressing down on plunger 5. Upon contact with the piercing shaft 3, the rigid inner chamber 13 is pierced by a hollow piercing shaft 3. As such, inert gas is allowed to transfer through piercing shaft 3 and into the headspace 111 of bottle 113.

The second preferred embodiment 200 preferably relies entirely on the force of gravity to cause the inert gas to travel through the piercing shaft 3 and into the headspace 111 of the wine bottle 113. Because the inert gas is denser than the air contained within the headspace 111, the inert gas will continue down the headspace 111 toward the surface of the remaining wine under the natural force of gravity. Ultimately, when equilibrium is reached, the inert gas generally displaces the oxygen-containing air that had been located at the surface of the remaining wine, and blankets the surface of the remaining wine with a thin layer of inert, food-friendly gas. The second preferred embodiment 200 preferably employs a rigid inner chamber 13 that does not collapse. As such, there is no significant pressurization within headspace 111 because the addition of food friendly gas into headspace 111 is coincident with an increase in the volume of the system (i.e., the volume of headspace 111 is increased because it now includes the volume of rigid inner chamber 13). Consequently, there is little or no pressurization of the headspace 111 when the inert gas is introduced via the piercing shaft 3. Thus, the second preferred embodiment 200 of WINE BLANKET™ preferably does not include an oxygen vent 14.

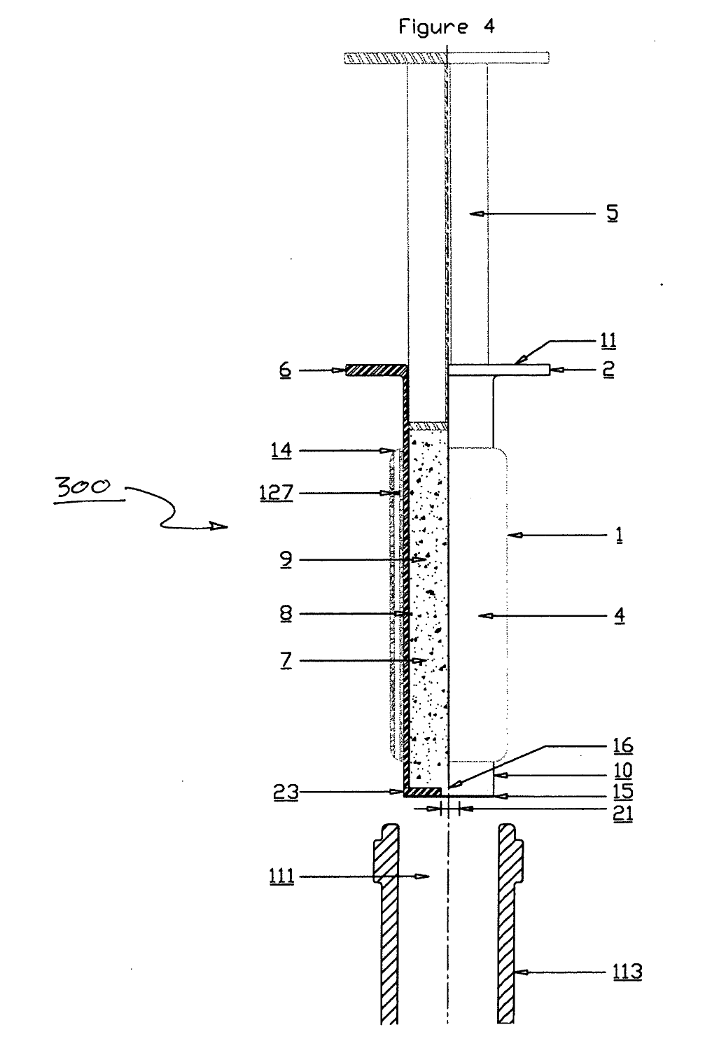

Alternatively, as seen in FIG. 4, a third preferred embodiment 300 of the WINE BLANKET™ preferably includes a cylindrical corking shaft 4 and a bottle collar 6. Shaft 4 and bottle collar 6 may comprise one contiguous element or two separate elements attached to each other. In any event, a cavity 9, which may resemble a cylindrical bore, preferably extends through the shaft 4 and bottle collar 6. One end of a plunger 5 fits snugly into cavity 9 at bottle collar 6.

After a wine bottle has been opened and partially consumed, the third preferred embodiment 300 of WINE BLANKET™ may be used to help preserve the quality of the remaining wine as follows.

The third preferred embodiment 300 may encapsulate the food friendly gas in cavity 9. The cavity 9, however, has a gas channel 16 that allows the user to transfer the food friendly gas from the third preferred embodiment 300 of WINE BLANKET™ to the headspace 111 of the wine bottle 113.

Prior to activation of the third preferred embodiment 300, the food friendly gas located within cavity 9 is prevented from exiting by a protective material 15 that covers gas channel 16. Just prior to activating the third preferred embodiment 300, the user may manually remove the protective material 15 to allow dispensation of the food friendly gas. The protective material 15 may comprise a tin or aluminum foil, or some other material that may be removable from the bottom of the shaft 4. The protective material may be attached to the shaft 4 by an adhesive or other suitable means.

Shortly after removing protective material 15, the user generally inserts the corking shaft 4 into the neck of the wine bottle 113. The shaft OD 1 (or corking shaft 4) preferably fits snugly with the ID of the neck of the wine bottle so that gases do not escape from the headspace 111 of the wine bottle 113. It is preferred that the corking shaft 4 be fully inserted into the neck of the wine bottle such that the bottom edge of bottle collar 6 abuts the lip of the wine bottle 113.

After insertion of the third preferred embodiment 300, the user may gently press the plunger 5, causing a decrease in the volume of cavity 9, which consequently pressurizes cavity 9. Because the increased pressure in cavity 9 will be greater than the pressure in headspace 111, the food friendly gas within cavity 9 will naturally move through the gas channel 16 and into headspace 111. The user may then continue to supply sufficient force to the plunger 5 causing all of the food friendly gas to transfer from cavity 9, through gas channel 16, into the headspace 111 of the wine bottle 113.

As the food friendly inert gas is introduced into the headspace 111 of the wine bottle 113, the headspace will naturally become pressurized. An oxygen vent 14 with a one-way valve 127 may be incorporated into the third preferred embodiment 300 to allow for the release of the less dense air that is displaced by the more dense food friendly inert gas. More specifically, the oxygen vent 14 preferably extends within shaft 4 and bottle collar 6 from the insertion end 10 to the cap end 11. As such, the oxygen vent 14 is in proximity to the upper portion of the headspace 111 occupied by the less dense air that has been displaced by the more dense inert gas acting under gravity and pressure from the activation of plunger 5. The third preferred embodiment 300 generally displaces enough air from the headspace 111 as is necessary to allow the inert gas to be introduced into the headspace 111 without significant pressurization of the headspace 111.

The blanketing layer of inert food friendly gas that ultimately settles on the surface of the remaining wine generally acts as a barrier, substantially preventing oxygen molecules in the headspace 111 from coming in direct contact with the wine. Oxidation is thus substantially prevented, and because the inert gas is safe and food-friendly, no significant chemical reactions occur between the inert gas and the remaining wine.

Thereafter, the user may remove the third preferred embodiment 300 of WINE BLANKET™ from the wine bottle and discard it. The remaining wine will have been subject to only minimal oxidization, thus helping preserve the integrity of the wine that existed when the wine bottle was first opened. The inert gas that acted as a protective barrier for the non-consumed wine harmlessly dissipates into the air after the third preferred embodiment 300 of WINE BLANKET™ is removed and the wine poured.

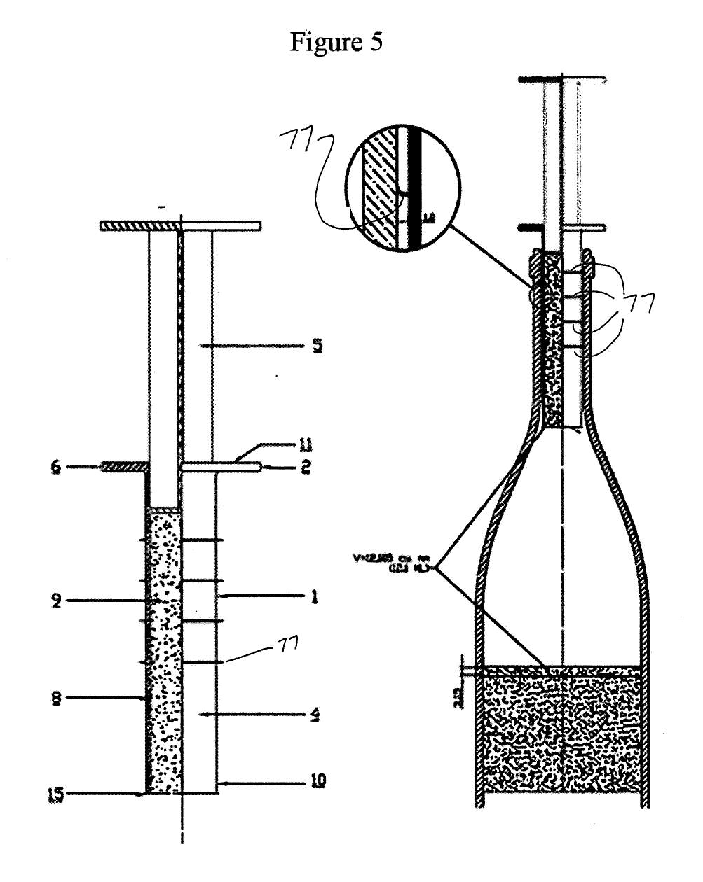

FIG. 5 shows another embodiment of the invention wherein the shaft 4 may include one or more ridges 77. The ridges 77 extend outward from the shaft 4 and are preferably flexible so that they may compress and/or flex in one direction or another, as shown in the enlargement portion of FIG. 5, to help take up space between the shaft 4 and wine bottle. In this manner, ridges 77 help accommodate varying inner diameters of wine bottle necks. Preferably, the shaft 4 is manufactured so that the ridges 77 form a contiguous part thereof. This provides the benefit of sealing the headspace of the wine bottle so that the inert gas may form a blanket on the wine surface.

The present invention has been described above in connection with several preferred embodiments. The above description is not intended to be limiting and the present invention may include variations of the foregoing.

What is claimed is:

1. An apparatus for preserving wine, comprising:
a shaft configured to be inserted into a wine bottle, the shaft defining a cavity therein, and having a hole at an end of the shaft;
a hollow piercing shaft located at the hole;
a plunger configured to snugly fit in the cavity of the shaft and to move towards the piercing shaft; and
a bladder containing an inert gas, the bladder being located within the cavity between the plunger and piercing shaft, and comprising a material capable of being pierced by the piercing shaft to release inert gas through the hollow piercing shaft and into the wine bottle when the plunger is moved towards the piercing shaft, the inert gas displacing air away from the wine surface.

2. The apparatus of claim 1 wherein the bladder is collapsable when the plunger moves towards the piercing shaft.

3. The apparatus of claim 2 wherein the collapsing of the bladder and movement of the plunger towards the piercing shaft increases the pressure within the wine bottle and facilitates the movement of the inert gas towards the wine surface to displace air.

4. The apparatus of claim 3, further comprising a vent to allow displaced air to exit the wine bottle.

5. The apparatus of claim 1 wherein the bladder comprises a rigid chamber that does not significantly collapse when the plunger moves toward the piercing shaft.

6. The apparatus of claim 5 wherein the overall volume comprising the volume of rigid chamber and volume of a headspace of the wine bottle does not substantially decrease when the plunger moves towards the piercing shaft, and the inert gas displaces air from the wine surface substantially through the force of gravity.

7. The apparatus of claim 1 wherein the inert gas has a density higher than air contained in the wine bottle and the inert gas displaces air in the wine bottle away from wine surface through the force of gravity.

8. The apparatus of claim 1 wherein the shaft includes a collar located at or near a second end of the shaft.

9. The apparatus of claim 8 wherein the collar abuts the wine bottle when the shaft is inserted into the wine bottle.

10. The apparatus of claim 1 wherein the shaft includes a vent having an inlet disposed within the wine bottle for allowing displaced air to exit the wine bottle.

11. The apparatus of claim 10, further comprising a one-way valve in the vent.

12. The apparatus of claim 11 wherein the vent and one-way valve are contained within a wall of the shaft.

13. The apparatus of claim 1 wherein the apparatus is removed from the wine bottle and discarded.

14. The apparatus of claim 1, further comprising one or more flexible ridges protruding outwardly from the shaft.

15. An apparatus for preserving wine, comprising:
a shaft configured to be inserted into a wine bottle, the shaft defining a cavity therein containing insert gas, and the shaft having a hole an end of the shaft;
a protective material that is removably attached to the shaft over the hole;
a plunger configured to snugly fit in the cavity of the shaft and to move towards the hole; and
wherein the protective material is removed from the shaft and the apparatus inserted into a wine bottle; the inert gas being released from the shaft through the hole and into the wine bottle as the plunger is moved towards the hole, the inert gas displacing air away from the wine surface.

16. The apparatus of claim 15, further comprising a vent having an inlet disposed within the wine bottle for allowing displaced air to exit the wine bottle.

17. The apparatus of claim 16, further comprising a one-way valve in the vent.

18. The apparatus of claim 15 wherein the apparatus is removed from the wine bottle and discarded.

19. The apparatus of claim 15, further comprising one or more flexible ridges protruding outwardly from the shaft.
